(19) United States
(12) Patent Application Publication
(10) Pub. No.: US 2017/0208523 A1
(43) Pub. Date: Jul. 20, 2017

(54) INTER RADIO ACCESS TECHNOLOGY MEASUREMENT DURING CONNECTED DISCONTINUOUS RECEPTION

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/996,148

(22) Filed: Jan. 14, 2016

(51) Int. Cl. H04W 36/30; H04W 36/00; H04W 76/04

(52) U.S. Cl. CPC H04W 36/30; H04W 76/048; H04W 36/0094

(57) ABSTRACT

A user equipment (UE) reduces call drops caused by a delayed transmission of a measurement report. In one instance, the UE enters a sleep duration in a current C-DRX cycle (connected discontinuous reception cycle) while in connected mode on a serving cell of a first RAT (radio access technology). The UE then evaluates one or more neighbor cells of a second RAT, for potential handover, during the sleep duration by performing inter radio access technology (IRAT) measurement. The UE also determines whether to wake up prior to a scheduled end of the sleep duration and send a scheduling request before the scheduled end when inter radio access technology (IRAT) measurement is completed. The determination can be based on a signal quality of the serving cell, a signal quality of the at least one neighbor cell, and a remaining time of the sleep duration in the current C-DRX cycle.

### BACKGROUND

Field

Aspects of the present disclosure relate generally to wireless communication systems, and more particularly, to performing measurements during a discontinuous reception (DRX) cycle.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method for wireless communication includes entering a sleep duration in a current C-DRX cycle (connected discontinuous reception cycle) while in connected mode on a serving cell of a first RAT (radio access technology). The method also includes evaluating one or more neighbor cells of a second RAT, for potential handover, during the sleep duration by performing inter radio access technology (IRAT) measurement. The method also includes determining whether to wake up prior to a scheduled end of the sleep duration and send a scheduling request before the scheduled end when inter radio access technology (IRAT) measurement is completed. The determination is based on a signal quality of the serving cell, a signal quality of the one or more neighbor cells and a remaining time of the sleep duration in the current C-DRX cycle.

According to another aspect of the present disclosure, an apparatus for wireless communication includes means for causing a user equipment (UE) to enter a sleep duration in a current C-DRX cycle (connected discontinuous reception cycle) while in connected mode on a serving cell of a first RAT (radio access technology). The apparatus may also include means for evaluating one or more neighbor cells of a second RAT, for potential handover, during the sleep duration by performing inter radio access technology (IRAT) measurement. The apparatus may also include means for determining whether to wake up prior to a scheduled end of the sleep duration and send a scheduling request before the scheduled end when inter radio access technology (IRAT) measurement is completed. The determination is based on a signal quality of the serving cell, a signal quality of the one or more neighbor cells and a remaining time of the sleep duration in the current C-DRX cycle.

Another aspect discloses an apparatus for wireless communication and includes a memory and one or more processors (e.g., at least one processor) coupled to the memory. The processor(s) is configured to cause a user equipment (UE) to enter a sleep duration in a current C-DRX cycle (connected discontinuous reception cycle) while in connected mode on a serving cell of a first RAT (radio access technology). The processor(s) is also configured to evaluate one or more neighbor cells of a second RAT, for potential handover, during the sleep duration by performing inter radio access technology (IRAT) measurement. The processor(s) is also configured to determine whether to wake up prior to a scheduled end of the sleep duration and send a scheduling request before the scheduled end when inter radio access technology (IRAT) measurement is completed. The determination is based on a signal quality of the serving cell, a signal quality of the one or more neighbor cells and a remaining time of the sleep duration in the current C-DRX cycle.

Yet another aspect discloses a non-transitory computer-readable medium having non-transitory program code recorded thereon which, when executed by the processor(s), causes the processor(s) to cause a user equipment (UE) to enter a sleep duration in a current C-DRX cycle (connected discontinuous reception cycle) while in connected mode on a serving cell of a first RAT (radio access technology). The program code also causes the processor(s) to evaluate one or more neighbor cells of a second RAT, for potential handover, during the sleep duration by performing inter radio access technology (IRAT) measurement. The program code further causes the processor(s) to determine whether to wake up prior to a scheduled end of the sleep duration and send a scheduling request before the scheduled end when inter radio access technology (IRAT) measurement is completed. The determination is based on a signal quality of the serving cell, a signal quality of the one or more neighbor cells and a remaining time of the sleep duration in the current C-DRX cycle.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in LTE.

FIG. 3 is a diagram illustrating an example of an uplink frame structure in LTE.

FIG. 4 is a block diagram illustrating an example of a global system for mobile communications (GSM) frame structure.

FIG. 5 is a block diagram conceptually illustrating an example of a base station in communication with a user equipment (UE) in a telecommunications system.

FIG. 6 is a block diagram illustrating the timing of channel carriers according to aspects of the present disclosure.

FIG. 7 is a diagram illustrating network coverage areas according to aspects of the present disclosure.

FIG. 8 is a flow diagram illustrating an example decision process for search and measurement of neighbor cells.

FIG. 9 illustrates an exemplary discontinuous reception communication cycle.

FIG. 10 is a timeline illustrating an example of a scheduling request implementation during a connected discontinuous reception cycle according to aspects of the present disclosure.

FIG. 11 is a flow diagram illustrating an exemplary method for determining whether to wake up early and send a scheduling request according to aspects of the present disclosure.

FIG. 12 is a flow diagram illustrating a method for performing measurements during a discontinuous reception cycle according to one aspect of the present disclosure.

FIG. 13 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

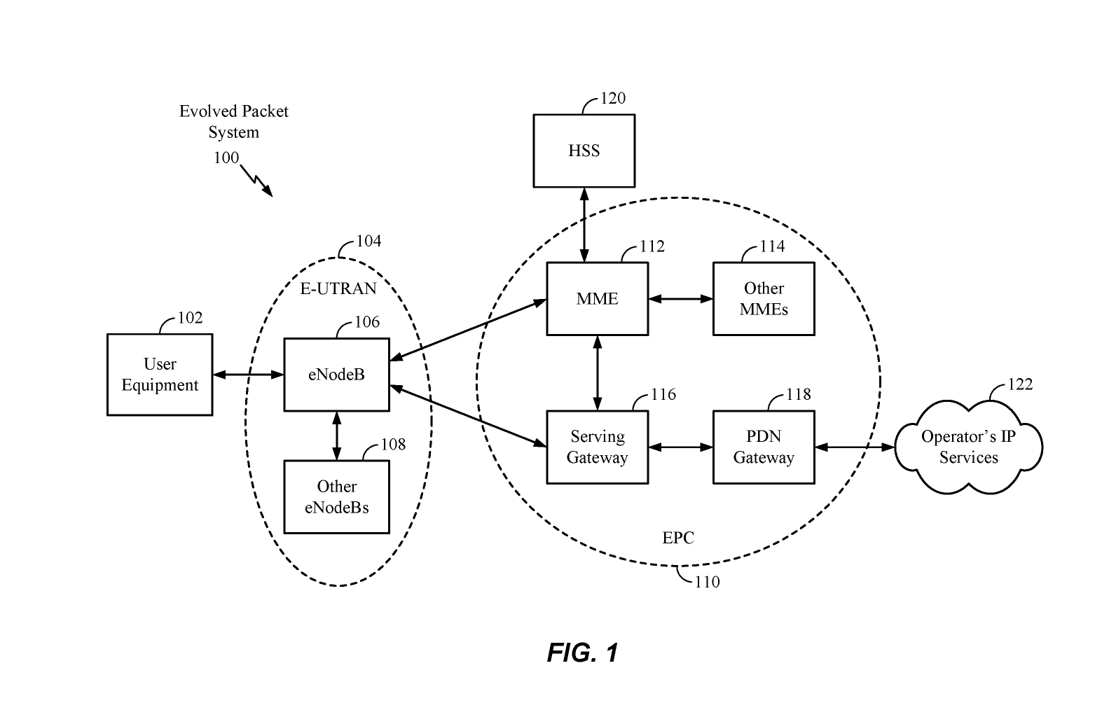

FIG. 1 is a diagram illustrating a network architecture 100 of a long-term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity, those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

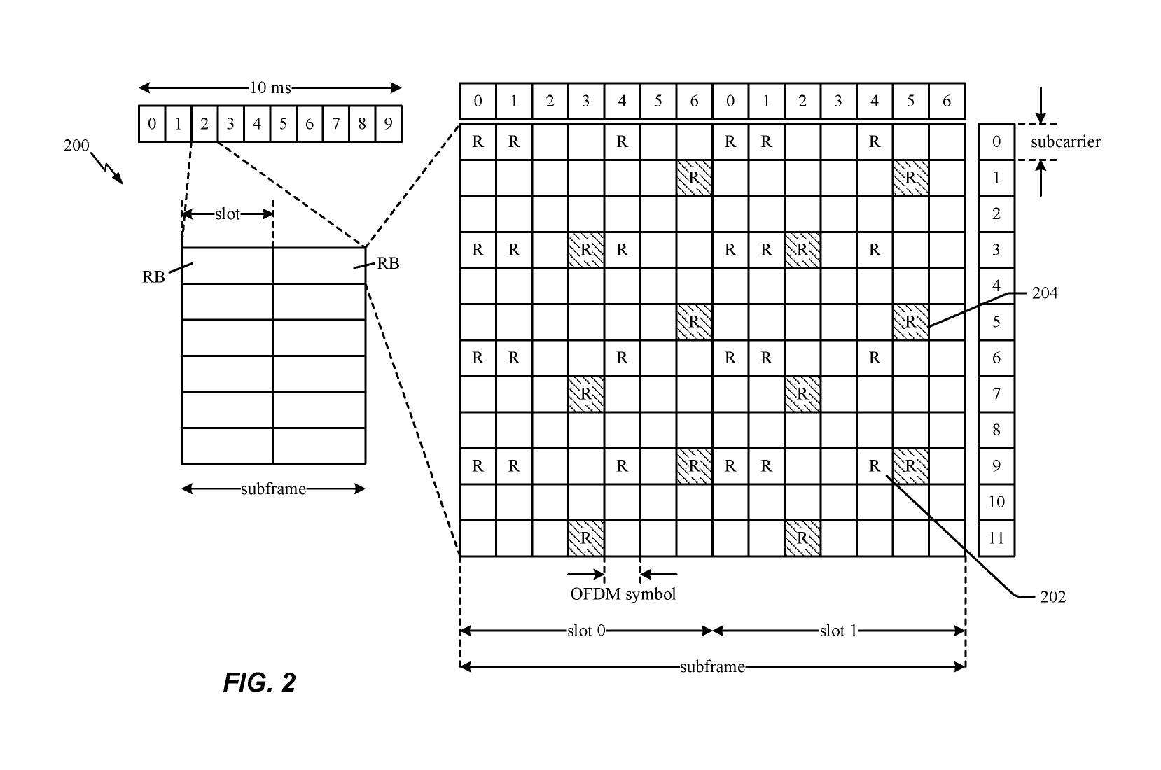

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204.

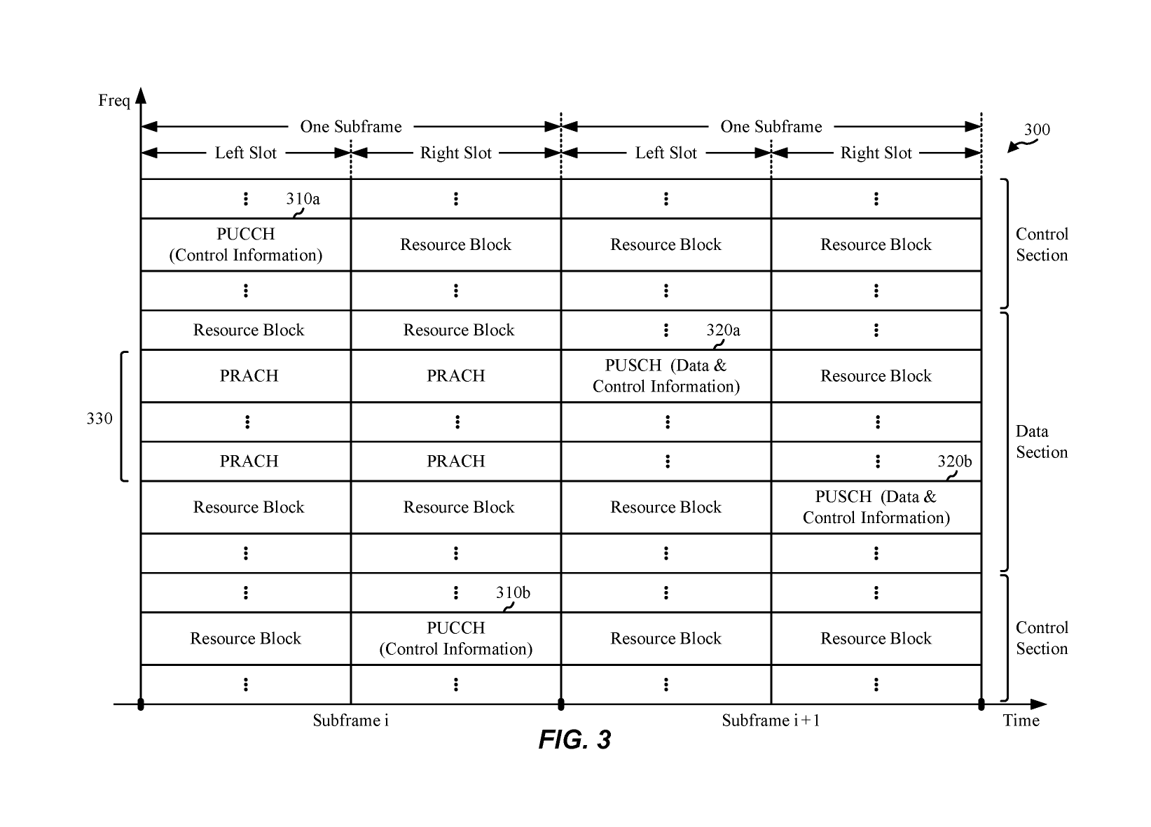

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. A set of resource blocks may be used to perform initial system access and achieve uplink synchronization in a physical random access channel (PRACH) 330.

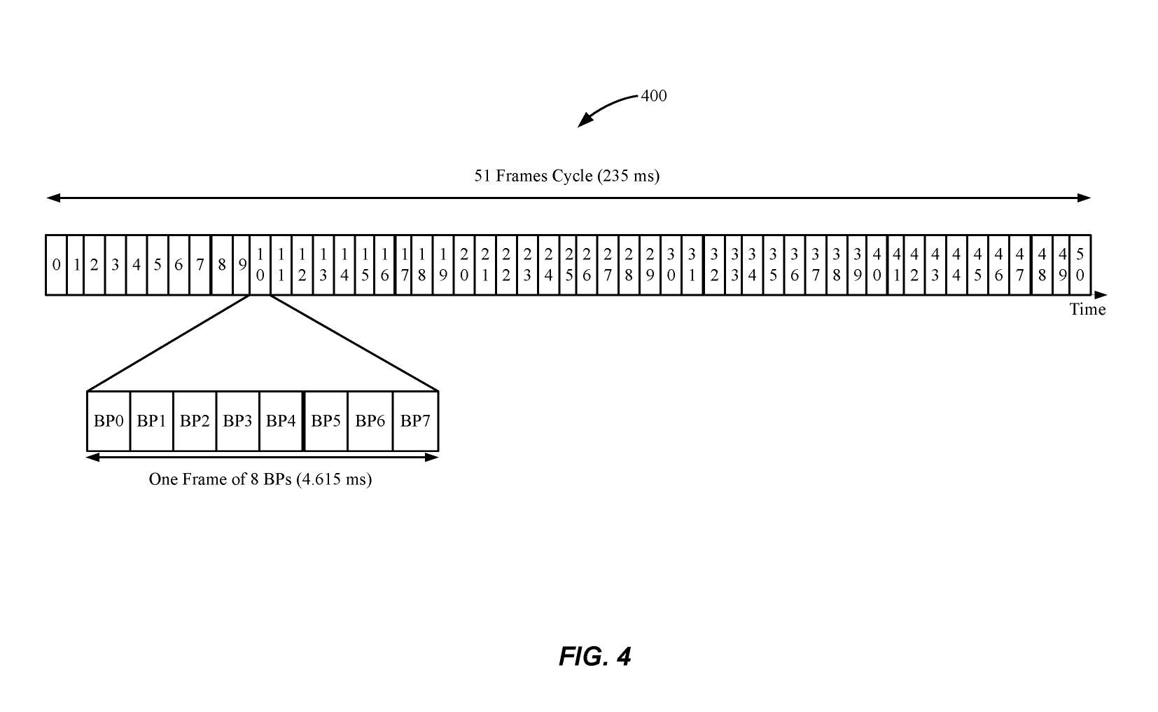

FIG. 4 is a block diagram illustrating an example of a GSM frame structure 400. The GSM frame structure 400 includes fifty-one frame cycles for a total duration of 235 ms. Each frame of the GSM frame structure 400 may have a frame length of 4.615 ms and may include eight burst periods, BP0-BP7.

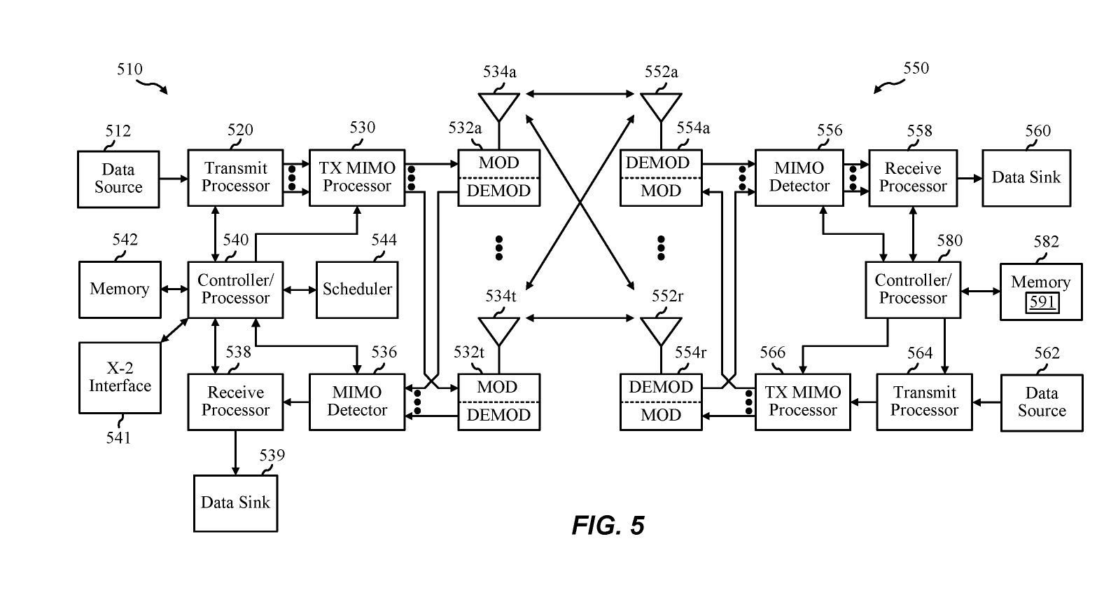

FIG. 5 is a block diagram of a base station (e.g., eNodeB or nodeB) 510 in communication with a UE 550 in an access network. In the downlink, upper layer packets from the core network are provided to a controller/processor 580. The base station 510 may be equipped with antennas 534a through 534t, and the UE 550 may be equipped with antennas 552a through 552r.

At the base station 510, a transmit processor 520 may receive data from a data source 512 and control information from a controller/processor 540. The processor 520 may process (e.g., encode and symbol map) the data and control information to obtain data symbols and control symbols, respectively. The processor 520 may also generate reference symbols. A transmit (TX) multiple-input multiple-output (MIMO) processor 530 may perform spatial processing (e.g., precoding) on the data symbols, the control symbols, and/or the reference symbols, if applicable, and may provide output symbol streams to the modulators (MODs) 532a through 532t. Each modulator 532 may process a respective output symbol stream (e.g., for OFDM, etc.) to obtain an output sample stream. Each modulator 532 may further process (e.g., convert to analog, amplify, filter, and upconvert) the output sample stream to obtain a downlink signal. Downlink signals from modulators 532a through 532t may be transmitted via the antennas 534a through 534t, respectively.

At the UE 550, the antennas 552a through 552r may receive the downlink signals from the base station 510 and may provide received signals to the demodulators (DEMODs) 554a through 554r, respectively. Each demodulator 554 may condition (e.g., filter, amplify, downconvert, and digitize) a respective received signal to obtain input samples. Each demodulator 554 may further process the input samples (e.g., for OFDM, etc.) to obtain received symbols. A MIMO detector 556 may obtain received symbols from all the demodulators 554a through 554r, perform MIMO detection on the received symbols if applicable, and provide detected symbols. A receive processor 558 may process (e.g., demodulate, deinterleave, and decode) the detected symbols, provide decoded data for the UE 550 to a data sink 560, and provide decoded control information to a controller/processor 580.

On the uplink, at the UE 550, a transmit processor 564 may receive and process data (e.g., for the PUSCH) from a data source 562 and control information (e.g., for the PUCCH) from the controller/processor 580. The processor 564 may also generate reference symbols for a reference signal. The symbols from the transmit processor 564 may be precoded by a TX MIMO processor 566 if applicable, further processed by the modulators 554a through 554r (e.g., for SC-FDM, etc.), and transmitted to the base station 510. At the base station 510, the uplink signals from the UE 550 may be received by the antennas 534, processed by the demodulators 532, detected by a MIMO detector 536 if applicable, and further processed by a receive processor 538 to obtain decoded data and control information sent by the UE 550. The processor 538 may provide the decoded data to a data sink 539 and the decoded control information to the controller/processor 540. The base station 510 can send messages to other base stations, for example, over an X2 interface 541.

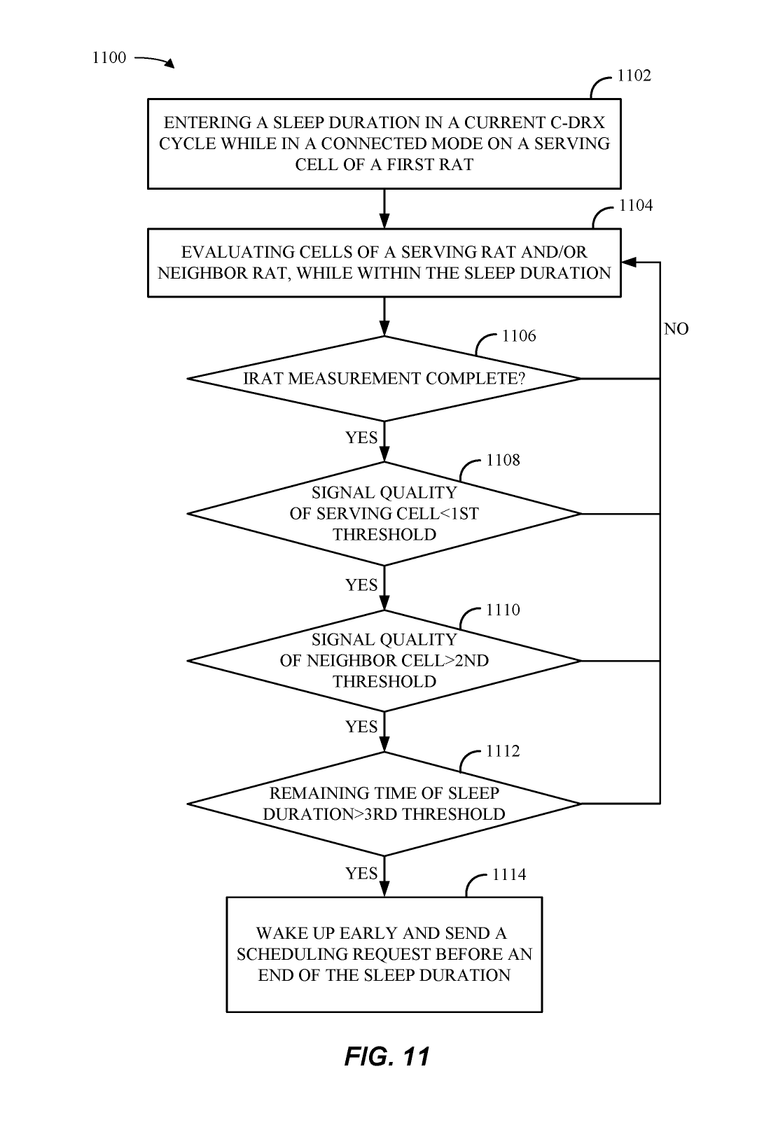

The controllers/processors 540 and 580 may direct the operation at the base station 510 and the UE 550, respectively. The processor 540/580 and/or other processors and modules at the base station 510/UE 550 may perform or direct the execution of the functional blocks illustrated in FIG. 11, and/or other processes for the techniques described herein. For example, the memory 582 of the UE 550 may store a scheduling request module 591 which, when executed by the controller/processor 580, configures the UE 550 to send a scheduling request during a discontinuous reception cycle according to one aspect of the present disclosure. The memories 542 and 582 may store data and program codes for the base station 510 and the UE 550, respectively. A scheduler 544 may schedule UEs for data transmission on the downlink and/or uplink.

In the uplink, the controller/processor 580 provides demultiplexing between transport and logical channels, packet reassembly, deciphering, header decompression, control signal processing to recover upper layer packets from the UE 550. Upper layer packets from the controller/processor 580 may be provided to the core network. The controller/processor 580 is also responsible for error detection using an ACK and/or NACK protocol to support HARQ operations.

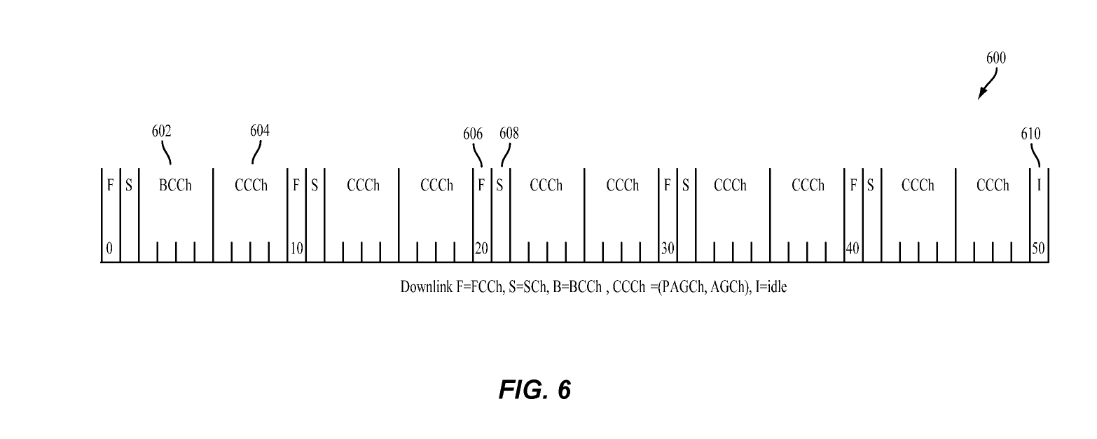

FIG. 6 is a block diagram 600 illustrating the timing of channels according to aspects of the present disclosure. The block diagram 600 shows a broadcast control channel (BCCH) 602, a common control channel (CCCH) 604, a frequency correction channel (FCCH) 606, a synchronization channel (SCH) 608 and an idle time slot 610. The numbers at the bottom of the block diagram 600 indicate various moments in time. In one configuration, the numbers at the bottom of the block diagram 600 are in seconds. In one configuration, each block of an FCCH 606 may include eight time slots, with only the first timeslot (or TSO) used for FCCH tone detection.

The timing of the channels shown in the block diagram 600 may be determined in a base station identity code (BSIC) identification procedure. The BSIC identification procedure may include detection of the FCCH carrier 606, based on a fixed bit sequence that is carried on the FCCH 606. FCCH tone detection is performed to find the relative timing between multiple RATs. The FCCH tone detection may be based on the SCH 608 being either a first number of frames or a second number of frames later in time than the FCCH 606. The first number of frames may be equal to 11+n·10 frames and the second number of frames may be equal to 12+n·10 frames. The dot operator represents multiplication and n can be any positive number. These equations are used to schedule idle time slots to decode the SCH. The first number of frames and the second number of frames may be used to schedule idle time slots in order to decode the SCH 608, in case the SCH 608 falls into a measurement gap or an idle time slot 610.

For FCCH tone detection in an inter RAT measurement, the FCCH may fully or partially fall within the idle time slots of the first RAT (not shown). The UE attempts to detect FCCH tones (for example, such as the FCCH 606) on the BCCH carrier of the n strongest BCCH carriers of the cells in the second RAT. The strongest cells in the second RAT may be indicated by a measurement control message. In one configuration, n is eight and the n BCCH carriers are ranked in order of the signal strength. For example, a BCCH carrier may be ranked higher than other BCCH carriers when the signal strength of the BCCH carrier is stronger than the signal strength of the other BCCH carriers. The top ranked BCCH carrier may be prioritized for FCCH tone detection.

Each BCCH carrier may be associated with a neighbor cell in the second RAT. In some instances, the UE receives a neighbor cell list including n ranked neighbor cells from a base station of the first RAT, for example, in a measurement control message. The neighbor cells in the neighbor cell list may be ranked according to signal strength. In some configurations, the n ranked neighbor cells may correspond to the n strongest BCCH carriers, such that system acquisition of the neighbor cells includes FCCH tone detection of these BCCH carriers.

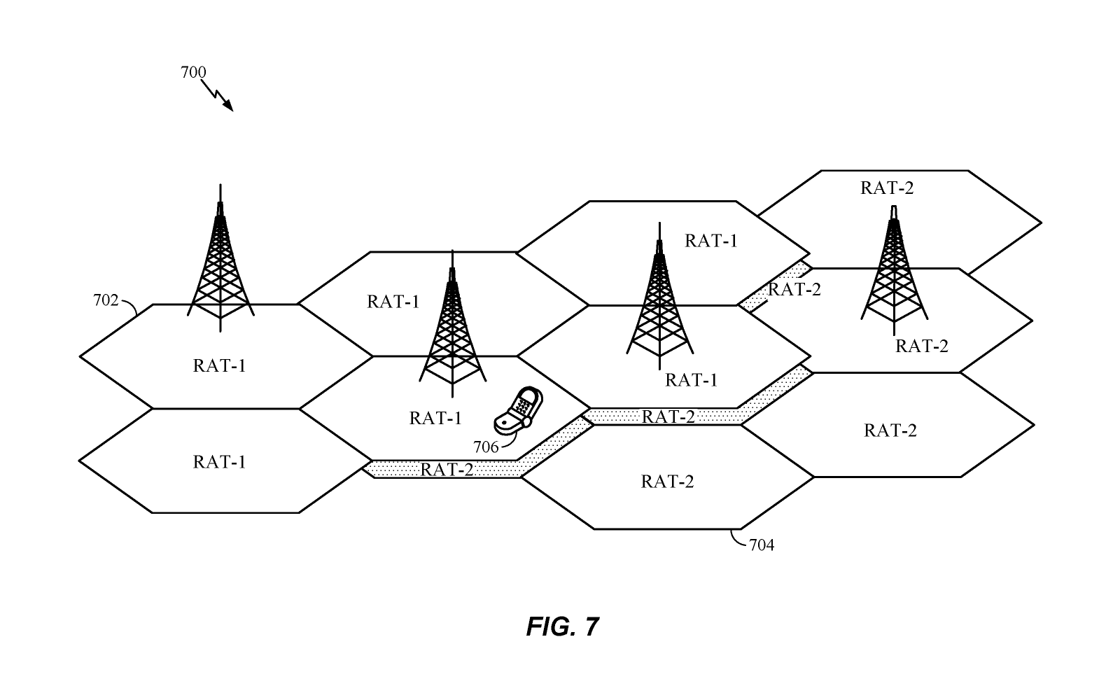

Some networks may be deployed with multiple radio access technologies. FIG. 7 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity.

In one example, the geographical area 700 includes RAT-1 cells 702 and RAT-2 cells 704. In one example, the RAT-1 cells are 2G or 3G cells and the RAT-2 cells are LTE cells. However, those skilled in the art will appreciate that other types of radio access technologies may be utilized within the cells. A user equipment (UE) 706 may move from one cell, such as a RAT-1 cell 702, to another cell, such as a RAT-2 cell 704. The movement of the UE 706 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., LTE) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Ongoing communication on the UE may be handed over from the first RAT to a second RAT based on measurements performed on the second RAT. For example, the UE may tune away to the second RAT to perform the measurements. The UE may handover communications according to a single radio voice call continuity (SRVCC) procedure. SRVCC is a solution aimed at providing continuous voice services on packet-switched networks (e.g., LTE networks). In the early phases of LTE deployment, when UEs running voice services move out of an LTE network, the voice services can continue in the legacy circuit-switched (CS) domain using SRVCC, ensuring voice service continuity. SRVCC is a method of inter radio access technology (IRAT) handover. SRVCC enables smooth session transfers from voice over internet protocol (VoIP) over the IP multimedia subsystem (IMS) on the LTE network to circuit-switched services in the universal terrestrial radio access network (UTRAN) or GSM enhanced date rates for GSM Evolution (EDGE) radio access network (GERAN).

LTE coverage is limited in availability. When a UE that is conducting a packet-switched voice call (e.g., voice over LTE (VoLTE) call) leaves LTE coverage or when the LTE network is highly loaded, SRVCC may be used to maintain voice call continuity from a packet-switched (PS) call to a circuit-switched call during IRAT handover scenarios. SRVCC may also be used, for example, when a UE has a circuit-switched voice preference (e.g., circuit-switched fallback (CSFB)) and packet-switched voice preference is secondary if combined attach fails. The evolved packet core (EPC) may send an accept message for PS Attach in which case a VoIP/IMS capable UE initiates a packet-switched voice call.

A UE may perform an LTE serving cell measurement. When the LTE serving cell signal strength or quality is below a threshold (meaning the LTE signal may not be sufficient for an ongoing call), the UE may report an event 2A (change of the best frequency). In response to the measurement report, the LTE network may send radio resource control (RRC) reconfiguration messages indicating 2G/3G neighbor frequencies. The RRC reconfiguration message also indicates event B1 (neighbor cell becomes better than an absolute threshold) and/or B2 (a serving RAT becomes worse than a threshold and the inter RAT neighbor becomes better than another threshold).

Handover in conventional systems may be achieved by performing IRAT measurements and/or inter frequency measurements. For example, the IRAT and/or inter frequency searches and/or measurements include LTE inter-frequency searches and measurements, 3G searches and measurements, GSM searches and measurements, etc., followed by base station identity code (BSIC) procedures. The measurements may be attempted in measurements gaps that are inadequate (e.g., short duration such as 6 ms gap) for completion of the measurement procedure. In one instance, BSIC procedures may not be accomplished because a base station identification information does not fall within the short duration measurement gap. The BSIC procedures include frequency correction channel (FCCH) tone detection and synchronization channel (SCH) decoding that are performed after signal quality measurements.

When the base station identification information falls outside of the short duration measurement gap, the UE may be unable to detect the base station identification information and may be unable to synchronize with a target cell. For example, using a conventional 6 ms gap for every predefined time period (e.g., 40 ms or 80 ms), the base station identification information (e.g., FCCH and/or SCH) may not occur within the short duration measurement gap. That is, the FCCH and/or SCH do not occur during a remaining 5 ms gap after a frequency tuning period of 1 ms. If the UE is unable to detect the base station identification, information communications may be interrupted. Further, repeated failed attempts by the UE may waste the UE's power.

The unpredictable failure of the FCCH/SCH to occur within the short duration measurement gap causes a variation of the IRAT measurement latency (e.g., increasing IRAT measurement latency). The failure of the FCCH/SCH to occur within the measurement gap may be due to a relative time between a serving RAT (e.g., LTE) and a neighbor RAT (e.g., GSM). The relative time impacts a time duration for the FCCH/SCH to fall into the 5 ms useful measurement gap (1 ms for frequency tuning). For example, the allocated time resources (e.g., frame timing) for the serving RAT and the neighbor RAT may be misaligned or offset, which causes failure of the FCCH/SCH to occur within the measurement gap of the serving RAT.

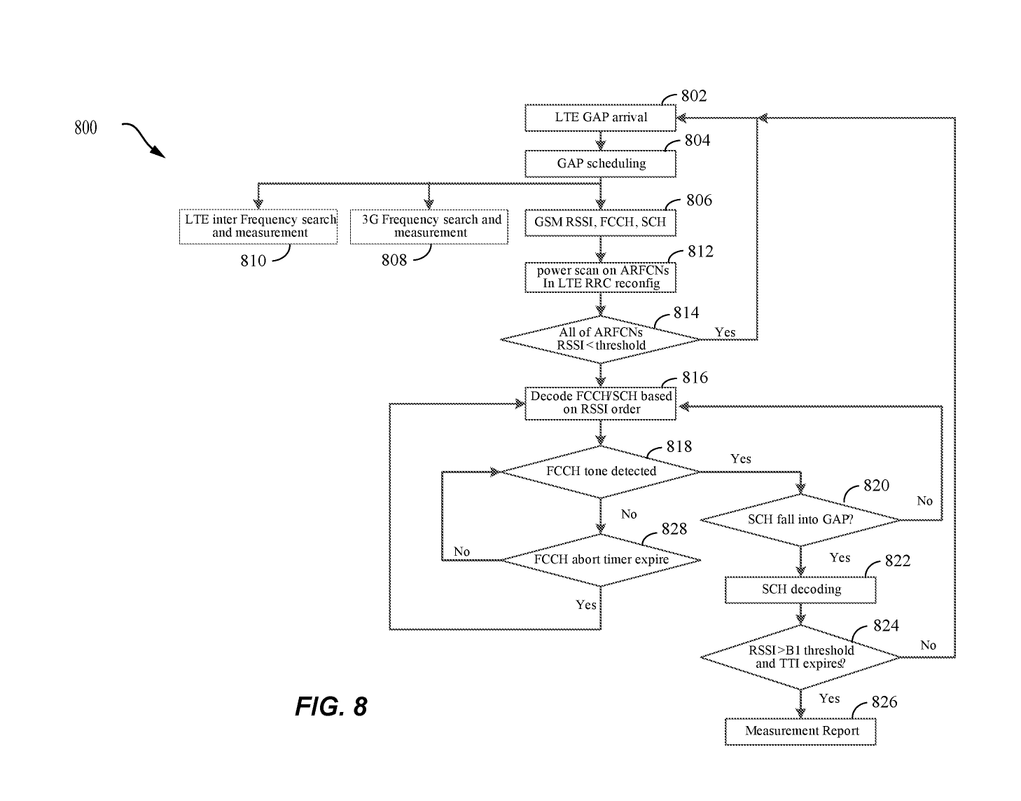

After the measurements, the UE may send a measurement report to the serving RAT. An exemplary search and measurement procedure is illustrated in FIG. 8. FIG. 8 is a flow diagram illustrating an example decision process for search and measurement of neighbor cells, for example an IRAT measurement with GSM. The measurement may occur when the UE is on a first RAT (e.g., LTE) with a short duration measurement gap (e.g., 6 ms) every predefined period (e.g., 40 ms or 80 ms). The searches and measurements may include inter frequency searches and measurements and inter radio access technology (IRAT) searches and measurements. At block 802, measurement gap information transmitted by a network of the first RAT is received by the UE. For example, the measurement gap for LTE is a 6 ms gap that occurs every 40 or 80 ms. The UE uses the measurement gap to perform 2G/3G (e.g., TD-SCDMA/WCDMA and GSM) searches and measurements and LTE inter frequency searches and measurements. A search and/or measurement schedule for the neighbor cells may be received by the UE from the network, as shown in block 804. The searches and measurements of the neighbor cells may be scheduled based on priority. For example, searches and measurements of LTE/TD-SCDMA neighbor cells or frequencies may have a higher priority than GSM neighbor cells. At blocks 806, 808 and 810, the UE performs inter radio access technology (IRAT) and/or inter frequency searches and/or measurements. The IRAT and/or inter frequency searches and/or measurements include LTE inter-frequency searches and measurements, 3G searches and measurements, GSM searches, measurements and BSIC procedures, respectively, according to the schedule.

The user equipment (UE) performs measurements by scanning frequencies (e.g., power scan), as shown in block 812. The UE then determines whether a signal quality of a serving cell of a first RAT and the signal quality of neighbor cells meet a threshold, as shown in block 814. For example, it is determined whether the signal qualities (e.g., RSSIs) of the neighbor cells are less than the threshold. The threshold can be indicated to the UE through dedicated radio resource control (RRC) (e.g., LTE RRC reconfiguration) signaling from the network. When the signal quality of the neighbor cells fails to meet a threshold, the process returns to block 802, in which the UE receives next measurement gap information. However, when the signal qualities of one or more target neighbor cells meet the threshold, the UE continues to perform the BSIC procedures, as shown in block 816. The BSIC procedures may be performed on the target neighbor cells in order of signal quality. For example, the BSIC procedures may be performed on the cell with the best signal quality, followed by the cell with the second best signal quality and so on. The BSIC procedures include frequency correction channel (FCCH) tone detection and synchronization channel (SCH) decoding that are performed after signal quality measurements.

In block 818, the UE may determine whether an FCCH tone is detected for a cell of the target cells (e.g., cell with best signal quality). If the FCCH tone is detected for the best cell, the UE determines whether the SCH falls into the measurement gap, as shown in block 820. In block 820, if the SCH does not fall into the measurement gap, the process returns to block 816, where the UE decodes FCCH/SCH for the target cell with the second best signal quality. However, if the SCH of the target neighbor cell with the best signal quality falls into the measurement gap, the UE performs SCH decoding, as shown in block 822.

The UE then determines whether the signal quality of the target neighbor cell is greater than the threshold (e.g., B1 threshold) and whether the TTI has expired, as shown in block 824. If the TTI expired and the signal quality of the target neighbor cell is not greater than the threshold, the process returns to block 802, where the UE receives the measurement gap information. However, if the TTI expired and the signal quality of the target neighbor cell is greater than the threshold, the process continues to block 826, where the UE sends a measurement report to the network. As noted, measurement reports are transmitted to a network only after the expiration of the TTI, even when the other conditions, such as RSSI being greater than the threshold are met.

When it is determined that the FCCH tone for the target neighbor cell is not detected at block 818, the process continues to block 828, where it is determined whether the FCCH abort timer expired. If the FCCH abort time is not expired, the process returns to block 818, where the UE continues to determine whether an FCCH tone is detected for the target neighbor cell. Otherwise, when it is determined that the FCCH abort timer expired at block 828, the process returns to block 816 where FCCH/SCH is decoded for the next target neighbor cell.

Power savings is important to ensure improved battery life for packet-switched devices (e.g., VoLTE devices) where voice calls (voice over internet protocol calls) can be frequent and long. During the voice over internet protocol calls, voice packet arrivals may exhibit traffic characteristics that are discontinuous. A discontinuous reception (DRX) mechanism may be implemented to reduce power consumption based on the discontinuous traffic characteristics of the voice packet arrivals.

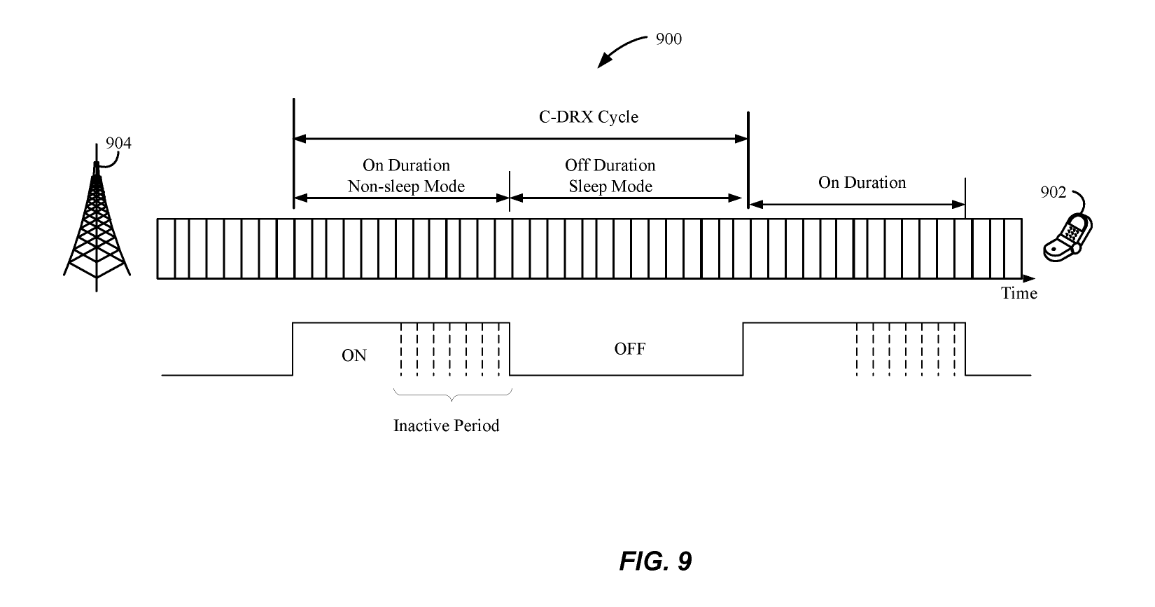

An exemplary discontinuous reception communication cycle 900 is illustrated in FIG. 9. The discontinuous reception cycle may correspond to a communication cycle where a user equipment (UE) 902 is in a connected mode (e.g., connected mode discontinuous reception (C-DRX) cycle). In the C-DRX cycle, the UE 902 may have an ongoing communication (e.g., voice call). For example, the ongoing communication may be discontinuous because of the inherent discontinuity in voice communications. The discontinuous communication cycle may also apply to other calls (e.g., multimedia calls).

The C-DRX cycle includes a time period/duration (e.g., C-DRX off duration or period) allocated for the UE 902 to sleep (e.g., sleep mode). In the sleep mode, the UE 902 may power down some of its components (e.g., receiver or receive chain is shut down). For example, when the UE 902 is in the connected state (e.g., RRC connected state) and communicating according to the C-DRX cycle, power consumption may be reduced by shutting down a receiver of the UE 902 for short periods. The C-DRX cycle also includes time periods when the UE 902 is awake (e.g., a non-sleep mode). The non-sleep mode may correspond to a time period (e.g., C-DRX on period) allocated for the UE to stay awake. The C-DRX on period includes a C-DRX on period and/or a C-DRX inactive period. The C-DRX on period corresponds to periods of communication (e.g., when the user is talking). The C-DRX inactive period, however, occurs during a pause in the communication (e.g., pauses in the conversation) that occurs prior to the C-DRX off period.

The UE 902 enters the sleep mode to conserve energy when the pause in the communication extends beyond a duration of an inactivity timer. A network may configure the inactivity timer. The inactivity timer defines the duration of the C-DRX inactive period. For example, the UE 902 enters the sleep mode when the inactivity timer initiated at a start of the pause, expires. In some implementations, a duration of the inactivity timer and corresponding C-DRX inactive period, the C-DRX on period and the C-DRX off period may be defined by the network. For example, the total DRX cycle may be 40 ms (e.g., one subframe corresponds to 1 ms). The C-DRX on period may have a duration of 4 subframes, the C-DRX inactive period may have a duration of 10 subframes and the C-DRX off period may have a duration of 26 subframes.

During the time period allocated for the non-sleep mode, such as the C-DRX inactive period, the UE 902 monitors for downlink information such as a grant. For example, the downlink information may include a physical downlink control channel (PDCCH) of each subframe. The PDCCH may carry information to allocate resources for UEs 902 and control information for downlink channels. During the sleep mode, however, the UE 902 skips monitoring the PDCCH to save battery power. To achieve the power savings, a serving base station (e.g., eNodeB) 904, which is aware of the sleep and non-sleep modes of the communication cycle, skips scheduling downlink transmissions during the sleep mode. Thus, the UE 902 does not receive downlink information during the sleep mode and can therefore skip monitoring for downlink information to save battery power.

For example, when the UE is in the connected state and a time between the arrival of voice packets is longer than the inactivity timer (e.g., inactivity timer expires between voice activity) the UE transitions into the sleep mode. A start of the inactivity timer may coincide with a start of the C-DRX inactive period of an ongoing communication. The end of the inactivity timer may coincide with a start of the sleep mode or an end to the non-sleep mode provided there is no intervening reception of data prior to the expiration of the inactivity timer. When there is an intervening reception of data, the inactivity timer is reset.

In some implementations, the UE is awake during the time period (e.g., C-DRX off period) allocated for the sleep mode. During the C-DRX off period, the UE evaluates neighbor cells by performing activities or measurement procedures. For example, the UE performs neighbor RAT (e.g., global system for mobile (GSM)) measurements (e.g., inter radio access technology (IRAT) measurements) for a list of frequencies (e.g., GSM absolute radio frequency channel numbers (ARFCNs)). The measurement procedures may include signal quality measurements and synchronization channel decoding procedures (e.g., frequency correction channel (FCCH) tone detection and/or synchronization channel (SCH) decoding).

After the signal quality measurements of the neighbor cells, the UE performs the FCCH tone detection and/or the SCH decoding for multiple frequencies of the neighbor RAT based on an order of signal quality until a scheduled end of the C-DRX off period. The UE then transitions to a C-DRX on period. After the UE transitions into the C-DRX on period, the UE sends a scheduling request, monitors for a grant channel, and then sends a measurement report using a received grant. However, delaying the measurement report until the scheduled end of the C-DRX off period may cause call drops when a signal quality of a serving cell of a first RAT (e.g., LTE serving cell) degrades quickly.

### Inter Radio Access Technology Measurement During Connected Discontinuous Reception

Aspects of the present disclosure are directed to reducing call drops caused by a delayed transmission of a measurement report. The measurement report may be generated based on an evaluation of neighbor cells during a connected discontinuous reception (C-DRX) off period of a current C-DRX cycle. A user equipment (UE) enters the C-DRX off period in the current discontinuous reception (DRX) cycle while in connected mode on a serving cell of a first or serving radio access technology (RAT).

In one aspect of the disclosure, when the UE enters the C-DRX off period, the UE does not fall asleep. Instead, the UE evaluates neighbor cells of a second or neighbor RAT. The serving RAT and the neighbor RAT may be different. The evaluation may include performing measurement procedures (e.g., inter radio access technology (IRAT) measurements). The measurement procedures may include signal quality measurements and base station identity code (BSIC) procedures. The signal quality measurements include, among others, received signal strength indication (RSSI) measurements and signal to noise ratio (SNR) measurements. The BSIC procedures include frequency correction channel (FCCH)/synchronization channel (SCH) decoding for one or more frequencies of the second RAT.

In some aspects of the disclosure, after the measurement procedures, the UE determines whether to wake up early and send a scheduling request before a scheduled end of the C-DRX off period. The scheduled end of the C-DRX off period may be specified by a network. The scheduling request may be a request for a grant to send the measurement report generated to report results of the measurement procedures. The determination of waking up early and sending the scheduling report may be based on whether various communication conditions are satisfied.

In one aspect of the disclosure, whether the communication condition is satisfied is based on a signal quality of the serving cell, a signal quality of one or more of the neighbor cells and a remaining time before the scheduled end of the C-DRX off period in the current DRX cycle. For example, the UE wakes up early and sends the scheduling request before the end of the C-DRX off period (or sleep duration) when the signal quality of the serving cell is below a first threshold, the signal quality of the one or more neighbor cells is above a second threshold and the remaining time of the sleep duration is above a third threshold. The remaining time is a time difference between finishing the measurement procedures in the current DRX cycle and the time when a next C-DRX on period in a next DRX cycle arrives.

In another aspect of the disclosure, when the UE sends the scheduling request prior to the scheduled end of the C-DRX off period, the UE monitors a grant channel. The grant channel may be monitored during the remaining time before the scheduled end of the C-DRX off period. For example, the UE may identify the time remaining for the C-DRX off period after the UE sends the scheduling request. The UE then monitors for a grant from the serving cell. After receiving the grant, the UE sends the measurement report to the base station in the remaining time before the scheduled end of the C-DRX off period to initiate the IRAT handover procedure. After the base station receives the measurement report, the base station sends the handover command to switch the UE from the serving RAT to the target RAT.

In yet another aspect of the present disclosure, the UE determines whether to wake up early and send the scheduling request based on a call status (e.g., current call setup status). The call status may be a call setup for communication on the UE. For example, the UE may determine whether to wake up early and send the scheduling request based on whether the call setup is complete. In this case, the UE may wake up earlier when the call setup is complete.

A call status for voice over internet protocol (VoIP) includes a pre-alert status (e.g., before alerting), an alert status (during alerting), VoIP call setup complete, bearer for internet protocol (IP) multimedia subsystem (IMS) signaling setup complete, bearer for VoIP traffic setup complete, and an in-call conversation status. The pre-alerting status and alerting status may occur prior to an in-call conversation status.

In one aspect, the UE wakes up earlier during a particular call status (e.g., call setup) when the network or UE supports IRAT handover (HO) during the call status (e.g., a current phase of the call status). In the pre-alert and alert status, the UE may sleep during the time remaining before the scheduled end of the C-DRX off period in scenarios when IRAT handover cannot occur during the pre-alert status and the alert status. This occurs when either the network or the UE does not support IRAT handover during the pre-alert status and the alert status. However, during the in-call conversation status, the UE may wake up early and send the scheduling request. The network then sends a grant to the UE, which uses the grant for uplink transmission.

In a further aspect of the disclosure, the UE may also determine whether to wake up early when the IRAT measurement is complete for a neighbor cell based on whether the neighbor cell is on a blacklist. The blacklist includes one or more cells on which the UE is prevented from seeking service or prevented from reporting measurements of the cell indicated in the blacklist.

In one aspect of the disclosure, the UE may also determine whether to wake up early when IRAT measurement is complete for a neighbor cell based on whether a serving base station supports pre-scheduling (e.g., uplink pre-scheduling). Whether the serving base station supports uplink pre-scheduling may be determined based on a record or history. For example, the UE may store a list of unique global identifications of base stations (e.g., eNodeBs) that support uplink pre-scheduling and may store other uplink pre-scheduling information. The other uplink pre-scheduling information may include a periodicity of the uplink pre-scheduling for periodic uplink pre-scheduling, a number of uplink pre-scheduling grants and a length of uplink pre-scheduled grants for non-periodic uplink pre-scheduling.

A base station that supports uplink pre-scheduling autonomously sends the UE uplink pre-scheduling information without receiving a scheduling request (e.g., periodically) from the UE. For example, when the uplink pre-schedule is executed, the base station periodically sends uplink grants without receiving a scheduling request from the UE. The uplink pre-scheduling information may convey various parameters for uplink data transmission. For example, the uplink pre-scheduling information may include an uplink grant that is received by the UE without the UE sending the schedule request for the uplink grant and/or uplink buffer status.

When the UE determines that the serving base station supports uplink pre-scheduling, the UE adjusts (e.g., delays) sending the scheduling request accordingly. For example, in a next non-sleep period, the serving cell (e.g., LTE cell) that supports uplink pre-scheduling may allocate an uplink grant without receiving a scheduling request from the UE. However, if no grant is expected to be allocated, the UE sends the scheduling request in the next non-sleep period during the next scheduling request occasion, and receives the uplink grant based on the scheduling request.

In another aspect of the disclosure, the UE delays sending the scheduling request when uplink pre-scheduling is supported by the serving base station based on the periodicity of the uplink pre-scheduling for periodic uplink pre-scheduling and/or the length of an uplink prescheduled grant for non-periodic uplink pre-scheduling. The periodicity of the uplink pre-scheduling and/or a length of an uplink prescheduled grants may be determined or identified based on the record. For example, the UE may record previous uplink pre-scheduling information such as uplink pre-scheduling periodicity and length of the uplink pre-scheduled grants in memory.

The UE may access the previously stored uplink pre-scheduling information to determine an expected scheduling request occasion and corresponding information associated with the scheduling request occasion. The corresponding information may include the uplink pre-scheduling periodicity that is used to determine when to expect a next scheduling request occasion and a length of the grant to expect in the next scheduling request occasion. For example, when the uplink pre-scheduling periodicity is short, the UE delays sending the scheduling request until the next scheduling request occasion. However, when the uplink pre-scheduling periodicity is long, the UE does not delay sending the scheduling request until the next scheduling request occasion.

In one aspect of the disclosure, the UE may also determine whether to wake up early when IRAT measurement is complete for a neighbor cell based on whether the UE is in a high speed scenario. The UE may determine whether it is in a high speed scenario, based on a global positioning system (GPS) measurement or input, a measured average Doppler frequency, a network indicator and/or a number of cell reselections and handovers within a predefined time window.

In a further aspect of the disclosure, the UE may also determine whether to wake up early when IRAT measurement is complete for a neighbor cell based on power headroom of the UE. The power headroom of the UE indicates how much transmission power is left for a UE to use in addition to the power being used by current transmission. For example, the UE wakes up early to send the scheduling request to the serving base station when the power headroom is small (e.g., below a threshold). However, the UE does not wake up early to send the scheduling request to the serving base station when the power headroom is large (e.g., above a threshold).

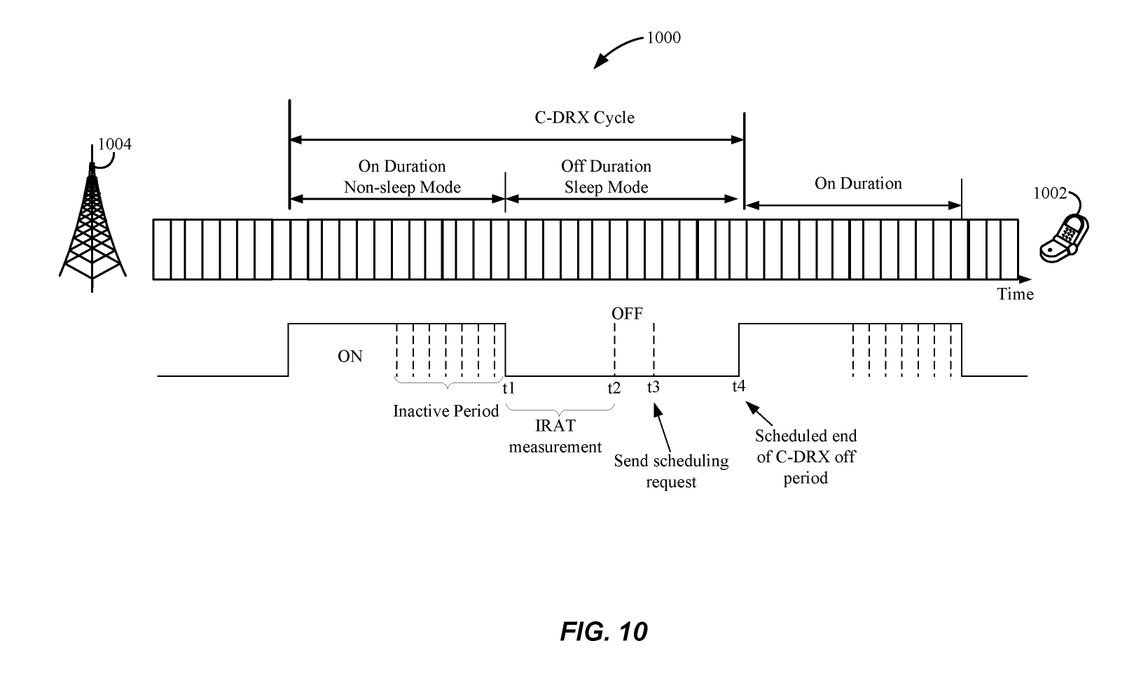

FIG. 10 is a timeline 1000 illustrating an example of a scheduling request implementation during a connected discontinuous reception (C-DRX) cycle according to aspects of the present disclosure. Similar to the discontinuous reception cycle illustrated in FIG. 9, the scheduling request implementation by the timeline 1000 is directed to wireless communication during a discontinuous reception cycle. For example, FIG. 10 illustrates a discontinuous reception cycle that corresponds to a communication cycle where a user equipment (UE) 1002 is in a connected mode. The C-DRX cycle includes a time period/duration (e.g., C-DRX off period) allocated for the UE 1002 to sleep. The UE 1002 enters the C-DRX off period to conserve energy when a pause in the communication extends beyond a duration of an inactivity timer.

In one aspect of the disclosure, the UE 1002 performs measurement procedures when the UE 1002 enters the C-DRX off period instead of falling asleep. For example, when the UE 1002 enters the C-DRX off period, at time t1, the UE 1002 performs IRAT measurements of neighbor cells of a neighbor RAT. During the C-DRX off period, the UE 1002 determines whether the IRAT measurement for one or more cells of the neighbor RAT is complete. When the IRAT measurement is complete, at time t2, the UE 1002 determines whether a signal quality of the serving cell of the first RAT is below a first threshold, whether the signal quality of the one or more neighbor cells is above a second threshold and whether the remaining time (e.g., t4-t2) before a scheduled end (e.g., at time t4) of the sleep duration is above a third threshold.

When the signal quality of the serving cell of the first RAT is below the first threshold, the signal quality of the one or more neighbor cells is above the second threshold and the remaining time before a scheduled end of the sleep duration is above the third threshold, the UE 1002 wakes up early (e.g., at time t3) and sends the scheduling request to a base station 1004 of the serving cell before the scheduled end (at time t4) of the sleep duration. Otherwise, the UE 1002 may sleep during the time remaining before a scheduled end of the sleep duration. In some implementations, the UE 1002 also monitors the grant channel between time t3 and t4 to locate a grant for sending the measurement report.

FIG. 11 is a flow diagram illustrating an exemplary method 1100 for determining whether to wake up early and send the scheduling request according to aspects of the present disclosure. A UE determines whether to wake up early and send the scheduling request based on a signal quality of the serving cell, a signal quality of one or more of the neighbor cells and a remaining time of the C-DRX off period in the current DRX cycle. The method 1100 starts with a user equipment (UE) entering a C-DRX off period, at block 1102. For example, the UE enters a sleep duration in a current connected discontinuous reception (C-DRX) cycle while in connected mode on a serving cell of the first or serving RAT. During the C-DRX off period, the UE evaluates cells of neighbor cells of a second or neighbor RAT, at block 1104. As noted, the evaluation may include performing measurement procedures for neighbor cells such as signal quality measurements and BSIC procedures.

The UE then determines whether the IRAT measurement is complete, at block 1106. When the IRAT measurement is complete, the method continues to block 1108. Otherwise, the method returns to block 1104 where the UE continues to evaluate the neighbor cells of the second RAT. At block 1108, the UE determines whether a signal quality of the serving cell of the first RAT is below a first threshold. When the signal quality of the serving cell of the first RAT is below the first threshold, the method continues to block 1110. Otherwise, the method returns to block 1104 where the UE continues to evaluate the cells of the first RAT and/or second RAT. Alternatively, the UE falls asleep for the remaining time before the scheduled end of the C-DRX off period or performs other desirable communication procedures.

At block 1110, the UE determines whether the signal quality of the one or more neighbor cells is above a second threshold. When the signal quality of the one or more neighbor cells is above the second threshold, the method continues to block 1112. Otherwise, the method returns to block 1104 where the UE continues to evaluate the cells of the first RAT and the second RAT. Alternatively, the UE falls asleep for the remaining time before the scheduled end of the C-DRX off period or the UE performs other desirable communication procedures.

At block 1112, the UE determines whether the remaining time of the sleep duration is above a third threshold. When the remaining time of the sleep duration is above the third threshold, the method continues to block 1114. Otherwise, the method returns to block 1104 where the UE continues to evaluate the neighbor cells of the first RAT and the second RAT. Alternatively, the UE falls asleep for the remaining time before the scheduled end of the C-DRX off period or the UE performs other desirable communication procedures. At block 1114, the UE wakes up early and sends the scheduling request before the end of the sleep duration.

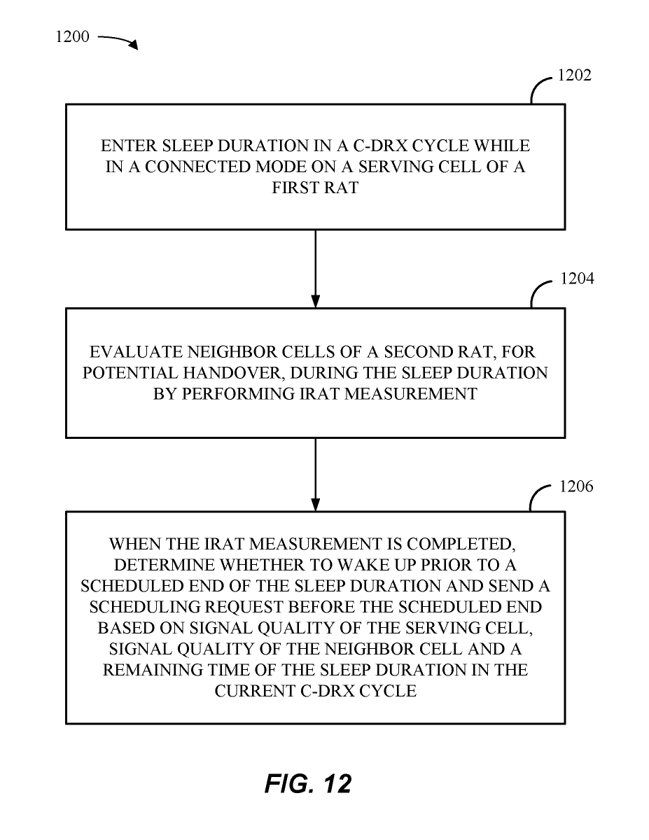

FIG. 12 is a flow diagram illustrating a method 1200 for sending a scheduling request during a discontinuous reception cycle according to one aspect of the present disclosure. The method reduces call drops caused by a delayed transmission of a measurement report. The measurement report may be generated based on an evaluation of neighbor cells during a connected discontinuous reception (C-DRX) off period of a current C-DRX cycle. At block 1202, a user equipment (UE) enters a sleep duration in a current C-DRX cycle (connected discontinuous reception cycle) while in connected mode on a serving cell of a first RAT (radio access technology). For example, the controller/processor 580 of the UE 550 of FIG. 5 causes the UE 550 to enter the sleep duration. At block 1204, the UE evaluates at least one neighbor cell of a second RAT, for potential handover, during the sleep duration by performing inter radio access technology (IRAT) measurement. For example, the controller/processor 580 of the UE 550 of FIG. 5 evaluates the neighbor cells of the second RAT during the sleep duration. At block 1206, when an inter radio access technology (IRAT) measurement is completed, the UE determines whether to wake up prior to a scheduled end of the sleep duration and send a scheduling request before the scheduled end. For example, the controller/processor 580 of the UE 550 of FIG. 5 determines whether to wake up early and send a scheduling request before an end of the sleep duration. The determination can based on a signal quality of the serving cell, a signal quality of one or more of the neighbor cells and a remaining time of the sleep duration in the current C-DRX cycle, as well as other conditions.

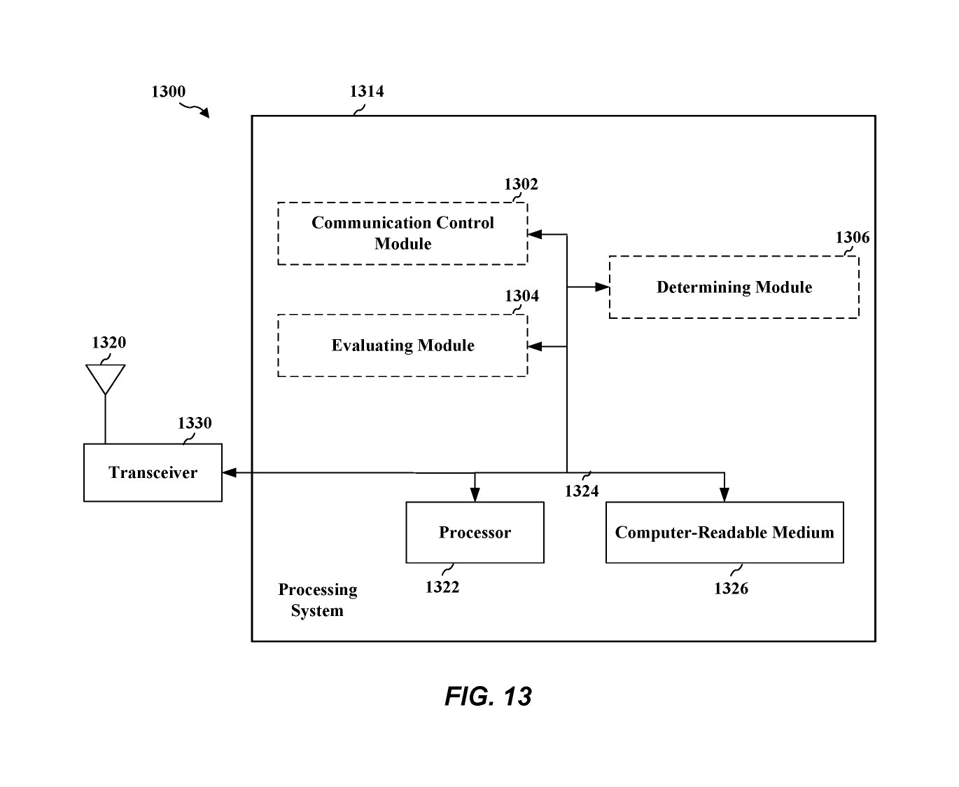

FIG. 13 is a diagram illustrating an example of a hardware implementation for an apparatus 1300 employing a processing system 1314 according to one aspect of the present disclosure. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1322, a communication control module 1302, an evaluating module 1304, a determining module 1306 and the non-transitory computer-readable medium 1326. The bus 1324 may also link various other circuits such as timing sources, peripherals, voltage regulators, and power management circuits, which are well known in the art, and therefore, will not be described any further.

The apparatus includes a processing system 1314 coupled to a transceiver 1330. The transceiver 1330 is coupled to one or more antennas 1320. The transceiver 1330 enables communicating with various other apparatus over a transmission medium. The processing system 1314 includes a processor 1322 coupled to a non-transitory computer-readable medium 1326. The processor 1322 is responsible for general processing, including the execution of software stored on the computer-readable medium 1326. The software, when executed by the processor 1322, causes the processing system 1314 to perform the various functions described for any particular apparatus. The computer-readable medium 1326 may also be used for storing data that is manipulated by the processor 1322 when executing software.

The processing system 1314 includes a communication control module 1302 for causing a user equipment to enter a sleep duration in a current C-DRX cycle (connected discontinuous reception cycle) while in connected mode on a serving cell of a first RAT (radio access technology). The processing system also includes an evaluating module 1304 for evaluating one or more neighbor cells of a second RAT, for potential handover, during the sleep duration by performing inter radio access technology (IRAT) measurement. The processing system also includes a determining module 1306 for determining whether to wake up prior to a scheduled end of the sleep duration and send a scheduling request before the scheduled end. The communication control module 1302, the evaluating module and/or the determining module may be software module(s) running in the processor 1322, resident/stored in the computer-readable medium 1326, one or more hardware modules coupled to the processor 1322, or some combination thereof. For example, when the communication control module 1302 is a hardware module, the communication control module 1302 includes the controller/processor 580 of FIG. 5. When the evaluating module 1304 is a hardware module, the evaluating module 1304 includes the controller/processor 580. When the determining module 1306 is a hardware module, the determining module 1306 includes the controller/processor 580. The processing system 1314 may be a component of the UE 550 of FIG. 5 and may include the memory 582, and/or the controller/processor 580.

In one configuration, an apparatus such as a UE 550 is configured for wireless communication including means entering a sleep duration or for causing the UE to enter the sleep duration. In one aspect, the sleep duration entering means may be the controller/processor 580 of FIG. 5, the memory 582 of FIG. 5, the scheduling request module 591 of FIG. 5, the communication control module 1302 of FIG. 13, and/or the processing system 1314 of FIG. 13 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE 550 is configured for wireless communication including means for evaluating. In one aspect, the evaluating means may be the controller/processor 580 of FIG. 5, the memory 582 of FIG. 5, the scheduling request module 591 of FIG. 5, the evaluating module 1304 of FIG. 13, and/or the processing system 1314 of FIG. 13 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE 550 is configured for wireless communication including means for determining. In one aspect, the determining means may be the controller/processor 580 of FIG. 5, the memory 582 of FIG. 5, the scheduling request module 591 of FIG. 5, the determining module 1306 of FIG. 13, and/or the processing system 1314 of FIG. 13 configured to perform the aforementioned means. In one configuration, the means functions correspond to the aforementioned structures. In another aspect, the aforementioned means may be a module or any apparatus configured to perform the functions recited by the aforementioned means.

In another aspect, an apparatus, such as a UE 550, may also include means for monitoring a grant channel. The monitoring means may be the controller/processor 580 of FIG. 5, the memory 582 of FIG. 5, and/or the processing system 1314 of FIG. 13 configured to perform the monitoring means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication comprising:
entering a sleep duration in a current C-DRX cycle (connected discontinuous reception cycle) while in connected mode on a serving cell of a first RAT (radio access technology);
evaluating at least one neighbor cell of a second RAT, for potential handover, during the sleep duration by performing inter radio access technology (IRAT) measurement; and
when inter radio access technology (IRAT) measurement is completed, determining whether to wake up prior to a scheduled end of the sleep duration and send a scheduling request before the scheduled end based at least in part on a signal quality of the serving cell, a signal quality of the at least one neighbor cell, and a remaining time of the sleep duration in the current C-DRX cycle.

2. The method of claim 1, further comprising
determining the signal quality of the serving cell is below a first threshold, the signal quality of the at least one neighbor cell is above a second threshold, and the remaining time of the sleep duration is above a third threshold; and
sending the scheduling request before the scheduled end based on the determining the signal quality of the serving cell is below the first threshold, the signal quality of the at least one neighbor cell is above the second threshold, and the remaining time of the sleep duration is above the third threshold.

3. The method of claim 2, further comprising monitoring a grant channel before the scheduled end, after sending the scheduling request.

4. The method of claim 1, wherein the determining is further based at least in part on a current call setup status and/or whether IRAT handover for the current call setup status is supported by a network and/or a user equipment.

5. The method of claim 1, wherein the determining is further based at least in part on whether the at least one neighbor cell is on a blacklist.

6. The method of claim 1, wherein the determining is further based at least in part on whether the serving cell performs uplink pre-scheduling.

7. The method of claim 1, wherein the determining is further based at least in part on a periodicity of uplink pre-scheduling for periodical uplink pre-scheduling and/or a length of an uplink prescheduled grant for non-periodical uplink pre-scheduling.

8. The method of claim 1, wherein the determining is further based at least in part on whether a UE (user equipment) is in a high speed scenario.

9. The method of claim 1, wherein the determining is further based at least in part on UE power headroom.

10. An apparatus for wireless communication comprising:
means for causing a UE (user equipment) to enter a sleep duration in a current C-DRX cycle (connected discontinuous reception cycle) while in connected mode on a serving cell of a first RAT (radio access technology);
means for evaluating at least one neighbor cell of a second RAT, for potential handover, during the sleep duration by performing inter radio access technology (IRAT) measurement; and
means for determining whether to wake up prior to a scheduled end of the sleep duration and send a scheduling request before the scheduled end, when inter radio access technology (IRAT) measurement is completed, based at least in part on a signal quality of the serving cell, a signal quality of the at least one neighbor cell, and a remaining time of the sleep duration in the current C-DRX cycle.

11. The apparatus of claim 10, further comprising means for sending the scheduling request before the scheduled end when the signal quality of the serving cell is below a first threshold, the signal quality of the at least one neighbor cell is above a second threshold, and the remaining time of the sleep duration is above a third threshold.

12. The apparatus of claim 11, further comprising means for monitoring a grant channel before the scheduled end, after sending the scheduling request.

13. The apparatus of claim 10, wherein the determining means further comprises means for determining based at least in part on a current call setup status and/or whether IRAT handover for the current call setup status is supported by a network and/or the user equipment.

14. The apparatus of claim 10, wherein the determining means further comprises means for determining based at least in part on whether the at least one neighbor cell is on a blacklist.

15. The apparatus of claim 10, wherein the determining means further comprises means for determining based at least in part on whether the serving cell performs uplink preschedule.

16. An apparatus for wireless communication comprising:
a memory;
a transceiver configured for wireless communication; and
at least one processor coupled to the memory and the transceiver, the at least one processor configured:
to cause a UE (user equipment) to enter a sleep duration in a current C-DRX cycle (connected discontinuous reception cycle) while in connected mode on a serving cell of a first RAT (radio access technology);
to evaluate at least one neighbor cell of a second RAT, for potential handover, during the sleep duration by performing inter radio access technology (IRAT) measurement; and
to determine whether to wake up prior to a scheduled end of the sleep duration and send a scheduling request before the scheduled end, when inter radio access technology (IRAT) measurement is completed, based at least in part on a signal quality of the serving cell, a signal quality of the at least one neighbor cell, and a remaining time of the sleep duration in the current C-DRX cycle.

17. The apparatus of claim 16, in which the at least one processor is further configured to cause the UE to send the scheduling request before the scheduled end when the signal quality of the serving cell is below a first threshold, the signal quality of the at least one neighbor cell is above a second threshold, and the remaining time of the sleep duration is above a third threshold.

18. The apparatus of claim 17, in which the at least one processor is further configured to monitor a grant channel before the scheduled end, after sending the scheduling request.

19. The apparatus of claim 16, in which the at least one processor is further configured to determine whether to wake up prior to the scheduled end based at least in part on a current call setup status and/or whether IRAT handover for the current call setup status is supported by a network and/or the UE.

20. The apparatus of claim 16, in which the at least one processor is further configured to determine whether to wake up prior to the scheduled end based at least in part on whether the at least one neighbor cell is on a blacklist.

21. The apparatus of claim 16, in which the at least one processor is further configured to determine whether to wake up prior to the scheduled end based at least in part on whether the serving cell performs uplink pre-scheduling.

22. The apparatus of claim 16, in which the at least one processor is further configured to determine whether to wake up prior to the scheduled end based at least in part on a periodicity of uplink pre-scheduling for periodical uplink pre-scheduling and/or a length of an uplink prescheduled grant for non-periodical uplink pre-scheduling.

23. The apparatus of claim 16, in which the at least one processor is further configured to determine whether to wake up prior to the scheduled end based at least in part on whether the UE is in a high speed scenario.

24. The apparatus of claim 16, in which the at least one processor is further configured to determine whether to wake up prior to the scheduled end based at least in part on power headroom of the UE.

25. A non-transitory computer-readable medium having non-transitory program code recorded thereon, the non-transitory program code comprising:
program code to cause a UE (user equipment) to enter a sleep duration in a current C-DRX cycle (connected discontinuous reception cycle) while in connected mode on a serving cell of a first RAT (radio access technology);
program code to evaluate at least one neighbor cell of a second RAT, for potential handover, during the sleep duration by performing inter radio access technology (IRAT) measurement; and
program code to determine whether to wake up prior to a scheduled end of the sleep duration and send a scheduling request before the scheduled end, when inter radio access technology (IRAT) measurement is completed, based at least in part on a signal quality of the serving cell, a signal quality of the at least one neighbor cell, and a remaining time of the sleep duration in the current C-DRX cycle.

26. The non-transitory computer-readable medium of claim 25, in which the non-transitory program code is further configured to cause the UE to send the scheduling request before the scheduled end when the signal quality of the serving cell is below a first threshold, the signal quality of the at least one neighbor cell is above a second threshold, and the remaining time of the sleep duration is above a third threshold.

27. The non-transitory computer-readable medium of claim 26, in which the non-transitory program code is further configured to monitor a grant channel before the scheduled end, after sending the scheduling request.

28. The non-transitory computer-readable medium of claim 25, in which the non-transitory program code is further configured to determine whether to wake up prior to the scheduled end based at least in part on a current call setup status and/or whether IRAT handover for the current call setup status is supported by a network and/or the UE.

29. The non-transitory computer-readable medium of claim 25, in which the non-transitory program code is further configured to determine whether to wake up prior to the scheduled end based at least in part on whether the at least one neighbor cell is on a blacklist.

30. The non-transitory computer-readable medium of claim 25, in which the non-transitory program code is further configured to determine whether to wake up prior to the scheduled end based at least in part on whether the serving cell performs uplink pre-scheduling.
